(19) United States
(12) Patent Application Publication
(10) Pub. No.: US 2006/0216644 A1
(43) Pub. Date: Sep. 28, 2006

(54) Method for preparing photosensitive aqueous developable coating composition

(76) Inventors: Jeong Ki Moon, Sungnam-Shi (KR); Yeong Seok Kim, Gunpo-Shi (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/445,081

(22) Filed: May 31, 2006

Related U.S. Application Data
(63) Continuation-in-part of application No. PCT/KR04/01604, filed on Jun. 30, 2004.

(30) Foreign Application Priority Data
May 18, 2004 (KR) 2004-35095

(51) Int. Cl. G03C 1/00

(52) U.S. Cl. 430/281.1

(57) ABSTRACT

A method for preparing a photosensitive aqueous developable coating composition is disclosed. The method does not involve a step of drying, pulverizing, and re-dissolving a solid polymer when preparing the coating composition. In addition, dilution of a polymerization solution by a solvent and a separate process for adjusting the viscosity of the polymerization solution are not needed. Therefore, the process for preparing the compositions can be simplified and undercut problems of a patterned edge during development and subsequent edge curl problems after a firing process can be overcome.

### CROSS-REFERENCE TO RELATED APPLICATIONS

This application is a continuation-in-part of International Application No. PCT/KR2004/001604, filed on Jun. 30, 2004, under the Patent Cooperation Treaty (PCT), designating the U.S., the disclosure of which is incorporated herein by reference in its entirety.

### BACKGROUND OF THE INVENTION

1. Field of the Invention

The present invention relates to a method for preparing a photosensitive aqueous developable film composition.

2. Description of the Related Technology

Photolithographically developable film compositions are widely used to form fine line circuits. The use of the composition allows formation of very fine lines having a line/space pitch of not greater than 100 μm. In this connection, U.S. Pat. Nos. 5,032,478, 5,049,480, 5,032,490 and 4,912,019 disclose aqueous developable film compositions which comprise gold, silver, copper and a ceramic material, respectively.

Typically, the photolithographically developable film compositions are prepared by mixing an inorganic powder (including metal powder), a photopolymerization initiator, a heat-assisted catalyst, a monomer and a water-washable organic binder, and dispersing the mixture. To form a fine circuit line, such a composition is applied to a substrate to form a layer in a uniform thickness, and is dried. The layer is then exposed to UV light, using a mask having a desired pattern. This process polymerizes the photo-reactive materials contained in the film composition. Portions of the layer which are exposed to UV light become insoluble in an aqueous developing solution. Subsequently, the layer is subjected to development to remove unexposed portions. Accordingly, only the exposed portions remain on the substrate, forming a pattern of features such as lines. The features are fired at a high temperature if needed. The organic binder in the composition serves to adhere the features to the substrate.

According to conventional methods for preparing these photolithographically developable film compositions, organic binder solutions are obtained by preparing a resin in a polymerization solvent through polymerization, solidifying the resin, pulverizing the solidified resin, and dissolving the pulverized resin in a suitable solvent. This process is time- and energy-consuming in that it involves solidifying, pulverizing, and re-dissolving the resin. Therefore, there is a need to simplify the process.

In connection with the characteristics of photolithographically developable film compositions, when patterns are formed by the methods described in U.S. Pat. Nos. 5,032,478, 5,049,480, 5,032,490 and 4,912,019, development gradient takes place along the thickness direction of lines. This development gradient causes inverse-trapezoidal undercuts. The undercuts are curved upwardly upon firing, resulting in edge curling. Therefore, there is a need to prevent such undercuts from occurring during development.

### SUMMARY OF CERTAIN INVENTIVE ASPECTS

One aspect of the invention provides a method of preparing a photolithographically developable composition. The method comprises: preparing a polymer solution by polymerizing a polymerizable compound in a solvent, the polymer solution comprising a polymer dissolved in the solvent; and mixing to the polymer solution a photosensitive material and one or more material selected from the group consisting of conductive particles and glass frit, thereby forming a photolithographically developable composition; wherein preparing the polymer solution does not comprise: pulverizing said polymer into smaller polymer pieces, and dissolving said polymer pieces in said solvent.

The polymer solution may have a viscosity from about 30 Pa·s to about 260 Pa·s prior to mixing the photosensitive material and one or more material selected from the group consisting of conductive particles and glass frit. Preparing the polymer solution may not comprise isolating said polymer from the polymer solution for pulverizing. Preparing the polymer solution may not comprise adding an additional amount of the solvent or another solvent to adjust viscosity of the polymer solution.

Preparing the polymer solution may not comprise adding a dispersing agent to the solution. Preparing the polymer solution may further comprise adjusting an amount of the polymerizable compound so as to make the acid value of the polymer solution from about 75 to about 125 mgKOH/g. The polymerizable compound may comprise alkylmethacrylate and alkylcarboxylic acid. The polymer may comprise a copolymer of alkylmethacrylate and alkylcarboxylic acid.

The solvent may be selected from the group consisting of butylcarbitol, butylcarbitol acetate, isopropyl acetate, butylcellosolveacetate, dibasic esters, ethyleneglycol acetate, cellosolveacetate, terpineol and higher aliphatic alcohols. The solvent may comprise 2,2,4-trimethyl-1,3-pentanediol monoisobutyrate.

Another aspect of the invention provides a photolithographically developable composition comprising a polymer, a photosensitive material and one or more material selected from the group consisting of conductive particles and glass frit, wherein the composition is made by the method described above. The polymer solution may have a viscosity from about 30 Pa·s to about 260 Pa·s prior to mixing the photosensitive material and one or more material selected from the group consisting of conductive particles and glass frit.

Another aspect of the invention provides a method of making an electronic device. The method may comprise: forming a layer of the photolithographically developable composition described above over a partially fabricated electronic device; and perform a photolithographical process to selectively remove a portion of the layer and cure the remainder.

Performing the photolithographical process may comprise: selectively illuminating on the layer to initiate a reaction of the photosensitive material therein, and selectively etching the layer to remove the portion. The photosensitive material may polymerize upon selective illumination. The remainder may comprise the conductive particles and constitute a conductive connection of the electronic device. The remainder may comprise the glass frit and constitute an insulating portion of the electronic device. The electronic device may comprise a plasma display device. The layer may be formed on a substantially transparent conductive material. The cured remainder may be more conductive than the substantially transparent conductive material.

Another aspect of the invention provides a method for preparing an aqueous photolithographically developable film composition. In the method, pulverizing and dissolution of a solid polymer is omitted, thereby simplifying the overall preparation process. At the same time, the formation of undercuts on patterns, such as lines, after development can be prevented, thereby overcoming problems caused after firing such as edge curling.

Yet another aspect of the invention provides a method for preparing a photosensitive aqueous developable coating composition without viscosity control using a solvent and without any limitation to the kind of inorganic components to be included in the composition. The method comprises the steps of preparing a binder resin in a polymerization solvent, mixing the organic binder solution with an inorganic powder, and dispersing the mixture, wherein the polymerization solvent is used as a solvent of the composition, the organic binder solution is directly used as one component of the composition without involving drying and solidification, and the acid value of the organic binder is adjusted to the range from about 75 to about 125 mgKOH/g.

### DETAILED DESCRIPTION OF CERTAIN INVENTIVE EMBODIMENTS

Various aspects and features of the invention will become more fully apparent from the following description.

A photolithographically developable composition prepared according to embodiments is used to form a patterned structure for an electronic device, for example, a display device. In the context of this document, a photolithographically developable composition may also be referred to as a photosensitive developable (film) composition. The patterned structures may form various shapes, for example, lines, layers, etc. The resulting structures may be either conductive or insulative. A method of forming such structures will be described later in detail.

The photolithographically developable composition may include an organic binder, a photocurable monomer, a photopolymerization initiator, other additives, and a solvent. Optionally, the composition may also include an inorganic binder. The organic binder is a polymer or resin which is soluble in an aqueous alkaline solution. The organic binder serves as a skeletal structure of the resulting feature. The photocurable monomer is an organic compound configured to be cross-linked to the organic binder upon exposure to light. The photopolymerization initiator initiates the polymerization of the monomer upon exposure to UV light. The inorganic binder serves to promote sintering of the conductive materials and imparting good adhesion to a substrate.

To form conductive structures, the composition further includes one or more conductive materials. On the other hand, to form insulative structures, the composition may include insulating materials. A skilled artisan will appreciate that various other additives can be added to obtain other desired properties of the composition.

Preparation of Composition

In one embodiment, the photolithographically developable composition is prepared as follows. First, a solution including a solvent and a polymerizable compound is provided. Then, the polymerizable compound is polymerized in the solution, thereby forming a polymer solution. In the polymer solution, a polymer is dissolved in the solvent. The polymer will serve as an organic binder in the photolithographically developable composition. Finally, the polymer solution is mixed with a photosensitive material and other functional materials, providing the photolithographically developable composition.

Examples of the polymerizable compound include, but are not limited to, monomers or oligomers for forming a polymer or resin such as acrylic, hydroxystyrene, novolak, and polyester resins. In one embodiment, an alkylmethacrylate and an alkylcarboxylic acid are used as polymerizable compounds to form a copolymer of an alkylmethacrylate and an alkylcarboxylic acid.

The solvent is chosen from solvents which can dissolve the polymerizable compound. In addition, the solvent should be suitable for use as a solvent for the photolithographically developable composition. For example, the solvent may have a boiling point between about 120° C. and about 260° C. In addition, the solvent should be able to dissolve the organic binder as well as its polymerizable compound. Examples of the solvent include butylcarbitol, butylcarbitol acetate, isopropyl acetate, butylcellosolveacetate, dibasic esters, ethyleneglycol acetate, cellosolveacetate, terpineol, and higher aliphatic alcohols. In one embodiment, 2,2,4-trimethyl-1,3-pentanediol monoisobutyrate is used. In one embodiment, the polymerization solvent is used in an amount of about 60% by weight with reference to the total weight of the solution.

In one embodiment, the solvent is first placed in a reactor. The solvent is then heated to about 80° C. with stirring. Then, for example, when the temperature of the solvent reaches a desired temperature, an alkylmethacrylate (e.g., MMA) and an alkylcarboxylic acid (e.g., MAA) are added. The polymerizable compound is polymerized in the solution, thereby forming the polymer solution. The polymerization may be initiated by adding a polymerization initiator to the reactor. In certain embodiments, the polymerizable compound and the polymerization initiator may be simultaneously added to the solvent which has been heated to a predetermined temperature. In one embodiment, the total amount of the monomers and initiator is about 40% by weight with reference to the total weight of the solution. The reactor is then slowly cooled to obtain an organic binder solution. The polymer (organic binder) thus synthesized has a molecular weight between about 5,000 and about 40,000. The resulting solution has the polymer in a dissolved state in the solvent.

In one embodiment, the polymer solution has a viscosity from about 30 Pa·s to about 260 Pa·s. The viscosity of the polymer is controlled to about 30 to about 260 Pa·s when measured at 10 rpm using a utility cup and spindle #14 of a Brookfield viscometer. The viscosity range is suitable for using the composition in a paste form.

In some embodiments, the acid value of the polymer solution may be controlled to reduce formation of edge curling or undercuts. The acid value may be controlled by adjusting the amount of a polymerizable compound which has a carboxyl group. In an embodiment where an alkylmethacrylate and an alkylcarboxylic acid are used as polymerizable compounds, the amount of the alkylcarboxylic acid may be adjusted to control the acid value. For example, the alkylcarboxylic acid may be in an amount between about 12 wt % and about 21 wt % with reference to the total weight of the polymerizable compounds. The acid value of the resulting polymer solution may be between about 75 and about 125 mgKOH/g.

Next, the polymer (organic binder) solution prepared as above is mixed with other components to form the photolithographically developable composition. The organic binder solution is directly used as one component of the composition without going through a series of solidification, pulverization, and redissolution of the polymer.

A photocurable monomer, a photopolymerization initiator, an inorganic binder, and other additives may be mixed with the polymer solution. An exemplary photocurable monomer is trimethylolpropane triacrylate. An exemplary photopolymerization initiator is 2,2-dimethoxy-1,2-diphenyletane-1-on. An exemplary inorganic binder is glass frit.

Other additives may also be mixed with the mixture prepared as described above, depending on desired properties of the composition. In an embodiment for making a conductive composition, one or more conductive materials are also mixed with the polymer solution. The conductive materials may be particulate. The conductive materials may be particles including metallic material, for example, Cu, Ag, Au, Ni, and alloys of two or more of the foregoing. In some embodiments, the foregoing metallic particles may be fully or partially coated with an insulating material. In another embodiment for making an insulative composition, an additional nonconductive inorganic material or filler may be added to the polymer solution. Certain additional additives, e.g., a catalyst, may also be added to obtain desired properties or to facilitate a desired chemical reaction.

In the method described above, a polymer (organic binder) is synthesized in a solvent. The methods, however, do not involve solidification, pulverization, and re-dissolution of the polymer unlike the convention methods described above.

Electronic Devices

Another aspect of the invention provides an electronic device including a circuit feature formed using the photolithographically developable composition described above. An exemplary device is a plasma display device (PDP).

Other examples of the electronic device may include, but is not limited to consumer electronic products, electronic circuits, electronic circuit components, parts of the consumer electronic products, electronic test equipments, etc. The consumer electronic products may include, but are not limited to, a mobile phone, a telephone, a television, a computer monitor, a computer, a hand-held computer, a personal digital assistant (PDA), a microwave, a refrigerator, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi functional peripheral device, a wrist watch, a clock, etc. Further, the electronic device may include unfinished products.

The electronic device can be made by the following process. The photolithographically developable film composition described above is applied to a substrate to form a layer in a uniform thickness. The layer is exposed to UV light through openings of a photo mask. The layer is then developed, curing exposed portions. The exposed portions are insoluble in an aqueous developing solution. Then, unexposed portions are stripped, thereby forming a pattern of features such as lines.

In a conventional method, development gradient along the thickness direction of lines upon developing causes inverse-trapezoidal undercuts. The undercuts are curled upwardly upon firing, resulting in an edge curling. According to the embodiments described above, however, an acid value of the organic binder can be optimized so as to prevent such undercuts. Because the acid value of the organic binder is optimized, the undercuts can be prevented without any limitation to the kinds of inorganic components to be included in the composition.

A better understanding to the invention may be obtained in light of the following examples which are set forth to illustrate, but are not to be construed to limit the invention.

### SYNTHESIS EXAMPLES

Each organic binder was synthesized in accordance with the following procedure. First, 60% by weight of a selected solvent was placed in a reactor, and was then heated to 80° C. with stirring. When the temperature reached the set point, an alkylmethacrylate (e.g., MMA) and an alkylcarboxylic acid (e.g., MAA) as monomers and a polymerization initiator were added in respective amounts indicated in Table 1 below to synthesize an organic binder. The monomers and the initiator were added in a total amount of 40% by weight with reference to the total weight of the mixture. When the organic binder had a molecular weight between 5,000 and 40,000, the reaction was quenched. The reactor was slowly cooled to obtain an organic binder solution. The organic binder solution thus obtained was used in subsequent examples.

The compositions of the components used to synthesize the respective organic binder solutions, and the acid values and viscosity of the respective organic binder solutions are summarized in Table 1 below.

TABLE 1

| | Syn. | Syn. | Syn. | Syn. | Syn. | Syn. | Syn. | Syn. |
|---|---|---|---|---|---|---|---|---|
| | Exam. 1 | Exam. 2 | Exam. 3 | Exam. 4 | Exam. 5 | Exam. 6 | Exam. 7 | Exam. 8 |
| Alkylmethacrylate (e.g., | 81.4 | 81.5 | 80.7 | 87.9 | 85.9 | 85.3 | 79.0 | 79.3 |
| MMA) | | | | | | | | |
| Alkylcarboxylic acid | 18.6 | 18.5 | 19.3 | 12.1 | 14.1 | 14.7 | 21.0 | 20.7 |
| (e.g., MAA) | | | | | | | | |
| Polymerization solvent | 2,2,4-trimethyl-1,3-pentanediol monoisobutyrate | | | | | | | |
| State of organic binders | Polymeric solution | | | | | | | |
| used | | | | | | | | |
| Acid value (mgKOH/g) | 115.5 | 110.4 | 115.5 | 72 | 83.72 | 85.1 | 129.4 | 124.6 |
| Viscosity (Pa · s) | 330 | 260 | 180 | 94 | 68 | 49.2 | 30 | 28.4 |

### EXAMPLES

Each of photosensitive aqueous developable coating compositions was prepared by mixing components in compliance with the compositions indicated in Tables 2 to 5, and kneading the mixture using a three-roll mill. The organic binder solutions prepared in Synthesis Examples 2 to 7 were used in Examples 1 to 6, the organic binder solution prepared in Synthesis Example 1 was used in Comparative Example 1, and the organic binder solution prepared in Synthesis Example 7 was used in Comparative Example 2, respectively. Each of the coating compositions was applied to a glass substrate to a uniform thickness using a 325 mesh screen. The applied glass substrate was dried on a hot plate at 80° C. to 90° C. for 10 minutes to obtain a thin film having a thickness of 10 microns. Next, the glass substrate was exposed to a UV light source at 400 mJ/cm² through a photomask on which a predetermined circuit pattern had been formed. The exposed glass substrate was subjected to development using a 0.4% Na₂CO₃ solution, conveyored sprayer (developing machine). The physical properties of the film compositions were evaluated, and the results are shown in Tables 2 to 5. The components to be added to the organic binder solutions are as follows:

Components

(1) Metal Powder

A spherical silver (Ag) powder having a specific surface area of 0.44 m²/g, a tap density of 5 g/ml and an average particle diameter of 1.8 μm was used. A spherical copper (Cu) powder with a specific surface area of 0.5 m²/g, a tap density of 4.8 g/ml and an average particle diameter of 2 μm was used.

(2) Glass Frit

In the case of a conductive coating composition, finely pulverized borosilicate glass frit having a softening temperature of 431° C. and an average particle diameter of 1.21 μm was used as an inorganic binder.

(3) Photoinitiator/catalyst/monomer

In the present examples, 2-methyl-1-[(4-methylthio)phenyl]-2-(4-morpholinyl)-1-propanone (sold under trade name Irgacure 907) was used as a photoinitiator. The photoinitiator is thermally inactive and generates free radicals upon exposure to UV light. As catalysts for better sensitization effects, ethyl-4-dimethylaminobenzoate (“EPD”) and isopropylthioxantone (“ITX”) were used.

As a monomer, which is polymerized by free radicals generated from the photoinitiator, imparting selectivity upon development, trimethylolpropane triacrylate (“TMPTA”, commercially available under trade name M300) was used.

(4) Inorganic Binder/inorganic filler/black Pigment (Insulating Composition)

In the case of an electrically insulating coating composition, finely pulverized borosilicate glass frit having a softening temperature of 470° C. and an average particle diameter of 1.9 μm was used as an inorganic binder. A TiO₂ powder having an average particle diameter of 0.251 μm and an oil absorption of 18 g/100 ml was used as an inorganic filler. As a black pigment used to obtain better photosensitivity, a Cr—Cu composite oxide having an average particle diameter of 0.8 μm and an oil absorption of 15 g/100 ml was used.

TABLE 2

| | Comp. | | | | | | | |
|---|---|---|---|---|---|---|---|---|
| | Exam. 1 | Exam. 1 | Exam. 2 | Exam. 3 | Exam. 4 | Exam. 5 | Exam. 6 | Comp. Exam. 2 |
| Silver powder | 70% | 70% | 70% | 70% | 70% | 70% | 70% | 70% |
| Glass frit | 5% | 5% | 5% | 5% | 5% | 5% | 5% | 5% |
| Monomer | 5% | 5% | 5% | 5% | 5% | 5% | 5% | 5% |
| Organic binder | 18.3% | 18.3% | 18.3% | 18.3% | 18.3% | 18.3% | 18.3% | 18.3% |
| Viscosity of organic binder | 330 | 260 | 180 | 94 | 67 | 49.2 | 30 | 28.4 |
| (Pa · s) | | | | | | | | |
| Irgacure 907 | 0.50% | 0.50% | 0.50% | 0.50% | 0.50% | 0.50% | 0.50% | 0.50% |
| EPD | 0.60% | 0.60% | 0.60% | 0.60% | 0.60% | 0.60% | 0.60% | 0.60% |
| ITX | 0.60% | 0.60% | 0.60% | 0.60% | 0.60% | 0.60% | 0.60% | 0.60% |
| Printability and viscosity of | Failed | Pass | Good | Good | Good | Good | Pass | Failed (16) |
| composition (Pa · s) | (79) | (45) | (36) | (28) | (26) | (21) | (18) | |

TABLE 3

| | Comparative | | | Comparative |
|---|---|---|---|---|
| | Example 3 | Example 7 | Example 8 | Example 4 |
| Silver powder | 70% | 70% | 70% | 70% |
| Glass frit | 5% | 5% | 5% | 5% |
| Monomer | 3% | 3% | 3% | 3% |
| Organic binder | 18.3% | 18.3% | 18.3% | 18.3% |
| Acid value of organic binder | 74.67 | 80.47 | 102.7 | 149 |
| (mgKOH/g) | | | | |
| Irgacure 907 | 0.50% | 0.50% | 0.50% | 0.50% |
| EPD | 0.60% | 0.60% | 0.60% | 0.60% |
| ITX | 0.60% | 0.60% | 0.60% | 0.60% |
| | Undercuts | | | |
| Drying at 80° C. for 10 min., | Not developable | 0 | 13 μm | ≧40 μm |
| Development for 60 sec. | | 0 | 4 μm | |
| | | 0 | 5 μm | |
| Result of evaluation | — | Good | Good | Failed |

Procedures for Evaluation of Physical Properties

Formation of undercuts: The formation of undercuts was observed using a 0.4% Na₂CO₃ solution, fixed sprayer and compared as a function of time in order to determine the effects of the method of the present invention. The measurement was done using an optical microscope connected to a recording device. After light exposure and development, circuit lines of the coating composition applied on the glass substrate were observed from the back side of the glass substrate. According to this procedure, since undercuts formed at end portions (edges) of the lines are not adhered to the glass substrate, the undercuts can be readily determined due to the contrast difference. The observation of the undercuts was conducted by taking a picture of the lines of the coating composition, which are portions corresponding to a photomask with a line width of 80 μm, at a magnification of 50×, and measuring distances (μm) from the end portions to the center of the lines using an image analyzer. Then, the measured values were compared. In view of the formation of undercuts and developability, the evaluation was judged to be “good” when the developed pattern was shown to be clean, and was judged to be “failed” when problems after firing, such as edge curling, were caused by undercuts formed on the line pattern after development.

TABLE 4

| | Example 9 |
|---|---|
| Copper powder | 70% |
| Glass frit | 5% |
| Monomer | 3% |
| Organic binder | 20.3% |
| Acid value of organic binder (mgKOH/g) | 84.63 |
| Irgacure 907 | 0.50% |
| EPD | 0.60% |
| ITX | 0.60% |

Undercuts

| | |
|---|---|
| Drying at 80° C. for 10 min., | 0 |
| Development for 60 sec. | 0 |
| | 0 |
| Result of evaluation | Good |

TABLE 5

| | Example 10 | Example 11 |
|---|---|---|
| Glass frit | 30% | 30% |
| TiO₂ | 12% | 12% |
| Black pigment | 8% | 8% |
| Monomer | 6% | 6% |
| Organic binder | 38.5% | 38.5% |
| Acid value of organic binder (mgKOH/g) | 74.6 | 124.6 |
| Irgacure 907 | 1.5% | 1.5% |
| EPD | 2.0% | 2.0% |
| ITX | 2.0% | 2.0% |

Undercuts

| | | |
|---|---|---|
| Drying at 80° C. for 10 min., | 0 | 0 |
| Development for 60 sec. | 0 | 0 |
| | 0 | 0 |
| Result of evaluation | Good | Good |

As can be seen from the results of Tables 2 to 5, according to the method of the embodiments, the formation of undercuts can be prevented by controlling the acid value of the organic binders using silver, copper or insulator powder. As apparent from the above description, the method is not limited in the kind of inorganic powders. In addition, since the viscosity control of the organic binders upon polymerization enables preparation of a paste having a desired viscosity, there is no need to further control the viscosity of the paste.

The methods for preparing a photosensitive aqueous developable film composition according to the embodiments above have the following advantages. Since dissolution of a solid polymer is omitted, the preparation process is simplified. In addition, since the formation of undercuts on patterns after development is prevented by controlling the acid value of the organic binder, problems caused after firing, such as edge curling, can be avoided. Furthermore, since the method is not limited to using specific kinds of inorganic powders, various inorganic powders suitable for a layer design can be used.

The foregoing description is that of embodiments of the invention and various changes, modifications, combinations and sub-combinations may be made without departing from the scope and spirit of the invention, as defined by the appended claims.

What is claimed is:

1. A method of preparing a photolithographically developable composition, comprising:
preparing a polymer solution by polymerizing a polymerizable compound in a solvent, the polymer solution comprising a polymer dissolved in the solvent; and
mixing to the polymer solution a photosensitive material and one or more material selected from the group consisting of conductive particles and glass frit, thereby forming a photolithographically developable composition;
wherein preparing the polymer solution does not comprise:
pulverizing said polymer into smaller polymer pieces, and
dissolving said polymer pieces in said solvent.

2. The method of claim 1, wherein the polymer solution has a viscosity from about 30 Pa·s to about 260 Pa·s prior to mixing the photosensitive material and one or more material selected from the group consisting of conductive particles and glass frit.

3. The method of claim 1, wherein preparing the polymer solution does not comprise isolating said polymer from the polymer solution for pulverizing.

4. The method of claim 1, wherein preparing the polymer solution does not comprise adding an additional amount of the solvent or another solvent to adjust viscosity of the polymer solution.

5. The method of claim 1, wherein preparing the polymer solution does not comprise adding a dispersing agent to the solution.

6. The method of claim 1, wherein preparing the polymer solution further comprises adjusting an amount of the polymerizable compound so as to make the acid value of the polymer solution from about 75 to about 125 mgKOH/g.

7. The method of claim 1, wherein the polymerizable compound comprises alkylmethacrylate and alkylcarboxylic acid.

8. The method of claim 1, wherein the polymer comprises a copolymer of alkylmethacrylate and alkylcarboxylic acid.

9. The method of claim 1, wherein the solvent is selected from the group consisting of butylcarbitol, butylcarbitol acetate, isopropyl acetate, butylcellosolveacetate, dibasic esters, ethyleneglycol acetate, cellosolveacetate, terpineol and higher aliphatic alcohols.

10. The method of claim 9, wherein the solvent comprises 2,2,4-trimethyl-1,3-pentanediol monoisobutyrate.

11. A photolithographically developable composition comprising a polymer, a photosensitive material and one or more material selected from the group consisting of conductive particles and glass frit, wherein the composition is made by the method of claim 1.

12. The composition of claim 11, wherein the polymer solution has a viscosity from about 30 Pa·s to about 260 Pa·s prior to mixing the photosensitive material and one or more material selected from the group consisting of conductive particles and glass frit.

13. A method of making an electronic device, the method comprising:
forming a layer of the photolithographically developable composition of claim 10 over a partially fabricated electronic device; and
perform a photolithographical process to selectively remove a portion of the layer and cure the remainder.

14. The method of claim 13, wherein performing the photolithographical process comprises:
selectively illuminating on the layer to initiate a reaction of the photosensitive material therein, and
selectively etching the layer to remove the portion.

15. The method of claim 14, wherein the photosensitive material polymerizes upon selective illumination.

16. The method of claim 13, wherein the remainder comprises the conductive particles and constitutes a conductive connection of the electronic device.

17. The method of claim 13, wherein the remainder comprises the glass frit and constitutes an insulating portion of the electronic device.

18. The method of claim 13, wherein the electronic device comprises a plasma display device.

19. The method of claim 18, wherein the layer is formed on a substantially transparent conductive material.

20. The method of claim 19, wherein the cured remainder is more conductive than the substantially transparent conductive material.
